(19) United States
(12) Patent Application Publication
(10) Pub. No.: US 2007/0041698 A1
(43) Pub. Date: Feb. 22, 2007

(54) Photosensitive resin composition for forming optical waveguide, optical waveguide, and method for forming optical waveguide pattern

(75) Inventors: Katsumi Maeda, Tokyo (JP); Kaichiro Nakano, Tokyo (JP); Masahiro Kubo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/488,864

(22) Filed: Jul. 19, 2006

(30) Foreign Application Priority Data
Aug. 16, 2005 (JP) 2005-235944

(51) Int. Cl. G02B 6/00

(52) U.S. Cl. 385/141; 385/129

(57) ABSTRACT

A photosensitive resin composition for forming an optical waveguide comprises, at least, a polymer comprising at least one repeating structural unit represented by the following general formula (1): 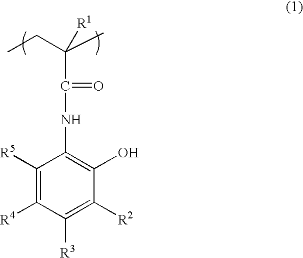
wherein R¹ represents a hydrogen atom or methyl group; and R² to R⁵ each independently represent a hydrogen atom, a halogen atom or an alkyl group having 1 to 4 carbon atoms, and a photoacid generator. This composition can form an optical waveguide pattern with excellent shape precision and at a low cost, and an optical waveguide of a low propagation loss.

### BACKGROUND OF THE INVENTION

1. Field of the Invention

The present invention relates to an optical waveguide, a photosensitive resin composition for forming an optical waveguide and a method for forming an optical waveguide pattern that are utilized for optical elements, optical interconnections, optical wiring boards, opto-electric hybrid circuit boards, etc., which are used in the fields of optical communication, optical information processing and the like.

2. Related Art

In recent years, with the rapidly spreading internet and digital home electric appliances, the capacity increase and the speeding-up of the information processing in communication systems and computers are demanded, and the high-speed transmission of data in high capacities by high-frequency signals is being studied. However, since, for transmitting signals in high capacities by high-frequency signals, conventional electric wiring is large in the propagation loss, transmission systems by light are extensively studied and are about to be used for wiring, etc. for communications between computers, in devices and in boards. Since, of elements to realize such a transmission system by light, the optical waveguide becomes a basic constituting element in optical elements, optical interconnections, optical wiring boards, opto-electric hybrid circuit boards, etc., it demands a high performance and a low cost.

As optical waveguides, quartz waveguides and polymer waveguides have been known till now. Among these, the quartz waveguides have a characteristic of a very low propagation loss, but demerits in the manufacturing process and cost such as a high processing temperature in the manufacturing process and a difficulty in fabricating large-area waveguides

On the other hand, since the polymer waveguides have advantages such as ease of processing and a large freedom of material design, those using a polymer material such as PMMA (polymethylmethacrylate), epoxy resin, polysiloxane derivative or fluorinated polyimide have been studied. For example, Japanese Patent Laid-Open Nos. 10-170738 and 11-337752 describe polymer waveguides using epoxy compounds. Japanese Patent Laid-Open No. 9-124793 describes a waveguide using a polysiloxane derivative.

However, polymer waveguides have noted problems of generally having a low thermal resistance and a large propagation loss in the range of 600 to 1,600 nm in wavelength used in optical communications. For solving the problems, studies have been made, for example, to reduce the propagation loss by a chemical modification such as deuteration or fluorination of a polymer and to use a polyimide derivative having thermal resistance. However, for example, a deuterated PMMA has a low thermal resistance. Although a fluorinated polyimide is excellent in thermal resistance, since for forming a waveguide pattern, a dry-etching process is necessitated as in quartz waveguides, the fluorinated polyimide has a disadvantage of a high manufacturing cost.

### SUMMARY OF THE INVENTION

Therefore, in forming an optical waveguide, which has a low propagation loss and is fabricable with high-precision in waveguide pattern and at a low cost by using a photosensitive resin, a suitable photosensitive resin composition, an optical waveguide and a method for forming an optical waveguide pattern are demanded.

As a result of studies to achieve the above objects, the present inventors have found that by using a photosensitive resin composition comprising a (meth)acrylamide polymer having a specific structure and a photoacid generator as constituting ingredients for a resin composition to form either or both of a core layer and a clad layer of an optical waveguide, suitable refractive indexes are imparted to respective layers; the waveguide can be formed with a low propagation loss; and moreover, a waveguide pattern can be formed with high-precision, and accomplished the present invention.

That is, the photosensitive resin composition for forming an optical waveguide of the present invention comprises, at least, a (meth)acrylamide polymer comprising at least a structural unit represented by the following general formula (1): 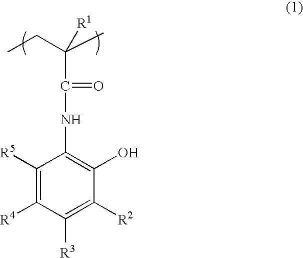
wherein R¹ represents a hydrogen atom or methyl group; and R² to R⁵ each independently represent a hydrogen atom, a halogen atom or an alkyl group having 1 to 4 carbon atoms, and a photoacid generator to generate an acid by light irradiation.

The photosensitive resin composition for forming an optical waveguide of the present invention, wherein the polymer further comprising a structural unit represented by the following general formula (2): 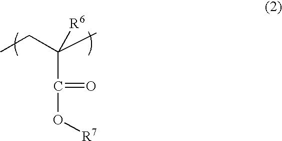
wherein R⁶ represents a hydrogen atom or methyl group; and R⁷ represents a hydrocarbon group having an epoxy group.

The photosensitive resin composition for forming an optical waveguide of the present invention further comprises an epoxy compound in addition to the polymer and photoacid generator.

The photosensitive resin composition for forming an optical waveguide of the present invention more preferably comprises, in addition to the polymer, photoacid generator and epoxy compound, at least one additive selected from the group consisting of alumina, silica, glass fiber, glass bead, silicone, titanium oxide and oxides of other metals.

The method for forming an optical waveguide of the present invention to achieve the above objects comprises at least following steps:

(1) forming a lower clad layer on a substrate;

(2) applying the photosensitive resin composition for forming an optical waveguide of the present invention to the lower clad layer;

(3) pre-baking the resin composition to fix the resin composition on the substrate;

(4) selectively exposing the resin composition;

(5) subjecting to post-exposure bake (PEB) treatment for promoting a reaction of the exposed area by an acid catalyst; and

(6) forming an upper clad layer on the layer of said resin composition after the above PEB.

The method may further comprise a developing step and a post-baking step after the step of the PEB.

Since the photosensitive resin composition for forming an optical waveguide of the present invention can form a waveguide pattern with high-precision and since the formed optical waveguide has an excellent transmission property (low propagation loss), the composition can suitably be used as a material for forming an optical waveguide.

### BRIEF DESCRIPTION OF THE DRAWINGS

FIG. 1(a) to FIG. 1(g) are schematic sectional views showing one embodiment of a manufacturing process of a polymer waveguide using a photosensitive resin composition according to the present invention; and

FIG. 2(a) to FIG. 2(g) are schematic sectional views showing another embodiment of a manufacturing process of a polymer waveguide using a photosensitive resin composition according to the present invention.

### DETAILED DESCRIPTION OF THE PREFERRED EMBODIMENTS

Hereinafter, a photosensitive resin composition for forming an optical waveguide and a forming method of an optical waveguide of the present invention will be explained.

<A Photosensitive Resin Composition for Forming an Optical Waveguide>

The photosensitive resin composition for forming an optical waveguide of the present invention (hereinafter, referred to as photosensitive resin composition) comprises a polymer comprising at least one repeating structural unit represented by the following general formula (1): 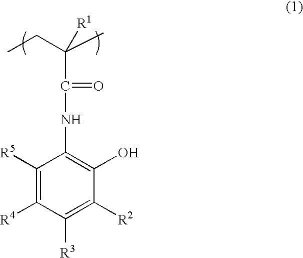
wherein R¹ represents a hydrogen atom or methyl group; and R² to R⁵ each independently represent a hydrogen atom, halogen atom or an alkyl group having 1 to 4 carbon atoms, and a photoacid generator, and can commonly be prepared by mixing the polymer and the photoacid generator.

In formula (1), R¹ represents a hydrogen atom or methyl group; and R² to R⁵ each independently represent a hydrogen atom, a halogen atom or an alkyl group having 1 to 4 carbon atoms. The halogen atom includes, for example, a fluorine atom and chlorine atom. The alkyl group having 1 to 4 carbon atoms includes, for example, a methyl group, ethyl group, n-propyl group, isopropyl group, n-butyl group and tert-butyl group.

The repeating structural unit represented by the general formula (1) includes following examples, but are not limited to these only. The structural unit may be used singly or in a combination of two or more.

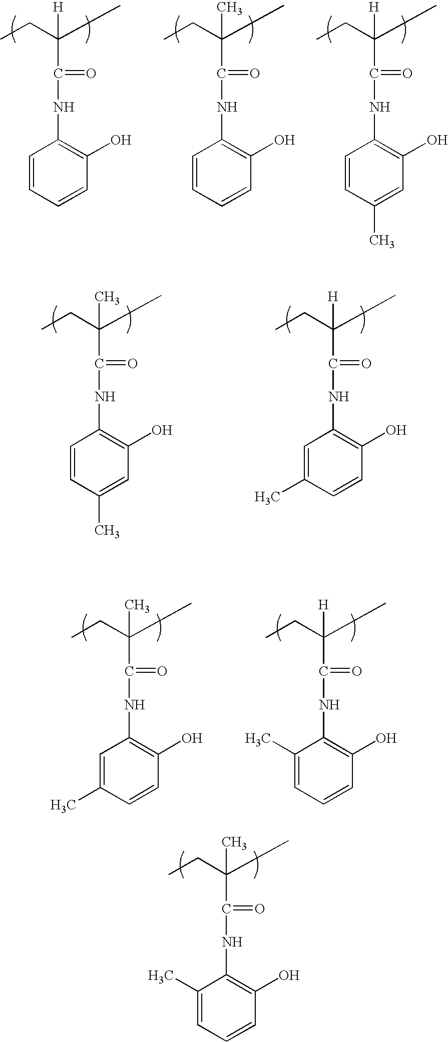

A polymer having the structural unit represented by the general formula (1) can be obtained by using a corresponding (meth)acrylamide compound as a raw material monomer and polymerizing by a well-known polymerization method, for example, solution polymerization, suspension polymerization and bulk polymerization. After the polymerization, the purification is desirably performed by a well-known method for removing the unreacted monomer, a polymerization initiator, etc.

The (meth)acrylamide compound of the raw material monomer is a well-known compound, and disclosed in a document (Research Reports of Faculty of Technology, Chiba University, vol. 26, No. 50, p 77-84 (1974)). For example, it can be obtained by a reaction of an o-aminophenol derivative and a halogenated (meth)acryloyl.

The polymer used in the photosensitive resin composition of the present invention may further comprise a structural unit having an epoxy group represented by the following general formula (2): 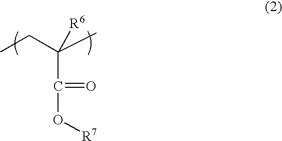
wherein R⁶ represents a hydrogen atom or methyl group; and R⁷ represents a hydrocarbon group having an epoxy group.

In formula (2), R⁶ represents a hydrogen atom or methyl group; and R⁷ represents a hydrocarbon group having an epoxy group. The hydrocarbon group having an epoxy group includes a glycidyl group, 3,4-epoxy-1-cyclohexylmethyl group, 5,6-epoxy-2-bicyclo[2.2.1]heptyl group, 5(6)-epoxyethyl-2-bicyclo[2.2.1]heptyl group, 5,6-epoxy-2-bicyclo[2.2.1]heptylmethyl group, 3,4-epoxytricyclo[5.2.1.0^{2,6}]decyl group, 3,4-epoxytricyclo[5.2.1.0^{2,6}]decyloxyethyl group, 3,4-epoxytetracyclo[4.4.0.1^{2,5}.1^{7,10}]dodecyl group and 3,4-epoxytetracyclo[4.4.0.1^{2,5}.1^{7,10}]dodecylmethyl group.

The introduction of the structural unit of the general formula (2) can be performed by mixing and polymerizing a corresponding (meth)acrylate having a hydrocarbon group containing an epoxy group with a (meth)acrylamide compound being a monomer ingredient of the general formula (1). The corresponding (meth)acrylate having a hydrocarbon group containing an epoxy group is commercially available. The structural unit of formula (2) may be used singly or in a combination of two or more.

The ratio of the structural unit of the general formula (1) to the structural unit of the general formula (2) is not especially limited, but is preferably in the range of 100:0 to 10:90 in a unit number ratio.

Further, a structural unit other than those of the general formula (1) and the general formula (2) can be contained in the polymer of the present invention. It includes a structural unit derived from a vinyl monomer, for example, (meth)acrylic acid, a (meth)acrylate and styrene.

The weight-average molecular weight (Mw) of the obtained polymer is preferably 1,000 or more, more preferably 4,000 or more. On the other hand, it is preferably 1,000,000 or less, more preferably 500,000 or less.

The photosensitive resin composition of the present invention may further comprise an epoxy compound in addition to the polymer and a photoacid generator. The epoxy compound includes, for example, a bisphenol A diglycidyl ether, hydrogenated bisphenol A diglycidyl ether, ethylene glycol diglycidyl ether, diethylene glycol diglycidyl ether, propylene glycol diglycidyl ether, tripropylene glycol diglycidyl ether, neopentyl glycol diglycidyl ether, 1,6-hexanediol diglycidyl ether, glycerin diglycidyl ether, trimethylolpropane triglycidyl ether, diglycidyl 1,2-cyclohexanecarboxylate, 3,4-epoxycyclohexylmethyl-3,4-epoxycyclohexanecarboxylate, tris(epoxypropyl) isocyanurate, 2-epoxyethylbicyclo[2.2.1]heptyl glycidyl ether, ethylene glycol bis(2-epoxyethylbicyclo[2.2.1]heptyl) ether and bis(2-epoxyethylbicyclo[2.2.1]heptyl) ether.

In the case of adding these epoxy compounds, the content ratio is commonly 0.5 to 80 mass % to the whole constituting ingredients containing itself, preferably 1 to 70 mass %. The epoxy compound can be used alone or by mixing two or more kinds.

A photoacid generator used in the present invention is desirably one which generates an acid by light irradiation of the light used in exposure, and is not especially limited as long as a mixture thereof with the polymer, etc. in the present invention is fully dissolved in an organic solvent, and the use of the resultant solution can form a uniform coating film by a film forming method such as spin coating. The photoacid generator can be used alone or by mixing two or more kinds.

Examples of usable photoacid generators include a triaryl sulfonium salt derivative, diaryl iodonium salt derivative, dialkylphenacyl sulfonium salt derivative, nitrobenzyl sulfonate derivative, sulfonic acid ester of N-hydroxynaphthalimide and a sulfonic acid ester derivative of N-hydroxysucciimide, but are not limited to these.

The content ratio of the photoacid generator is preferably 0.1 mass % or more, more preferably 0.5 mass % or more, to the total of the polymer, epoxy compound and photoacid generator from the viewpoint of achieving a sufficient sensitivity of the photosensitive resin composition and enabling the favorable pattern formation. On the other hand, it is preferably 15 mass % or less, more preferably 7 mass % or less, from the viewpoint of achieving the uniform coating film formation and not impairing the properties of the waveguide.

The photosensitive resin composition of the present invention may be added, in addition to the polymer, photoacid generator and optionally added epoxy compound, with various additives in the range of not impairing the properties for an optical waveguide. The additives include, for example, alumina, silica, glass fiber, glass bead, silicone, titanium oxide and metal oxide. Addition of these additives allows the cracking resistance and two thermal resistance to be improved, a low elasticity to be achieved, as well as the warping of the waveguide to be improved.

In preparing the photosensitive resin composition, an appropriate solvent is optionally used. The solvent is an organic solvent which is not especially limited as long as it can fully dissolve the photosensitive resin composition, and the resultant solution can be uniformly coated by the spin coating method, etc. Specifically usable are γ-butyrolactone, propylene glycol monomethyl ether acetate, propylene glycol monoethyl ether acetate, ethyl lactate, 2-heptanone, 2-methoxybutyl acetate, 2-ethoxyethyl acetate, methyl pyruvate, ethyl pyruvate, methyl 3-methoxypropionate, ethyl 3-methoxypropionate, N-methyl-2-pyrrolidone, cyclohexanone, cyclopentanone, methyl isobutyl ketone, ethylene glycol monomethyl ether, ethylene glycol monomethyl ether acetate, ethylene glycol monoethyl ether, ethylene glycol monoisopropyl ether, diethylene glycol monomethyl ether, diethylene glycol dimethyl ether, etc. These may be used alone or by mixing two or more kinds.

Further, the photosensitive resin composition of the present invention can be prepared by optionally adding other ingredients such as an adhesiveness improving agent and coating applicability improving agent.

A feature of the photosensitive resin composition of the present invention is that exposure makes a photoacid generator contained in the composition generate an acid, which promotes the crosslinking reaction, and heat-curing thereafter generates a difference in refractive index between the exposed part and the unexposed part. That is, the feature is that the refractive index of the exposed part decreases more than that of the unexposed part. Further, the difference in crosslinking degree results in a difference of solubility between the exposed part and the unexposed part, and the development treatment allows only the unexposed part to be selectively removed.

<A Forming Method of a Waveguide Pattern>

The manufacture of a polymer optical waveguide according to the present invention will be explained. A polymer optical waveguide is composed of a core of a high refractive index and a clad of a low refractive index, is formed in a shape in which the core is enclosed in the clad, and is obtained by a forming method of a waveguide pattern comprising at least the following steps:

(1) forming a lower clad layer on a suitable substrate;

(2) applying the photosensitive resin composition of the present invention on the lower clad layer;

(3) pre-baking the resin composition to form a resin composition layer;

(4) irradiating, with actinic rays such as ultraviolet rays, through a mask, the resin composition layer, an area other than an area to be a core layer, specifically, an area corresponding to a middle clad layer formed on the sides of the core layer;

(5) subjecting to PEB treatment; and

(6) forming an upper clad layer on the resin composition layer after the PEB.

In the present invention, either or both of the lower clad layer and the upper clad layer may be formed by similarly irradiating the photosensitive resin composition of the present invention with actinic rays.

A polymer optical waveguide of the present invention can also be obtained by a conventionally known method of performing development treatment. That is, the method comprises at least the following steps:

(1) forming a lower clad layer on a suitable substrate;

(2) applying the photosensitive resin composition of the present invention on the lower clad layer;

(3) pre-baking the resin composition to form a resin composition layer;

(4) irradiating an area to be a core layer of the resin composition layer with actinic rays such as ultraviolet rays through a mask;

(5) subjecting to PEB treatment;

(6) developing to remove the unexposed area;

(7) post-baking to form the core layer; and

(8) forming a middle and upper clad layer on the formed core layer and the lower clad layer formed as described above.

Either or both of the lower clad and the middle and upper clad layers may be formed by similarly irradiating the photosensitive resin composition of the present invention with actinic rays. But, in this case, the composition is selectively used such that all the clad layers have a lower refractive index than the core layer.

Hereinafter, manufacturing methods of a polymer optical waveguide according to the present invention will be explained in detail.

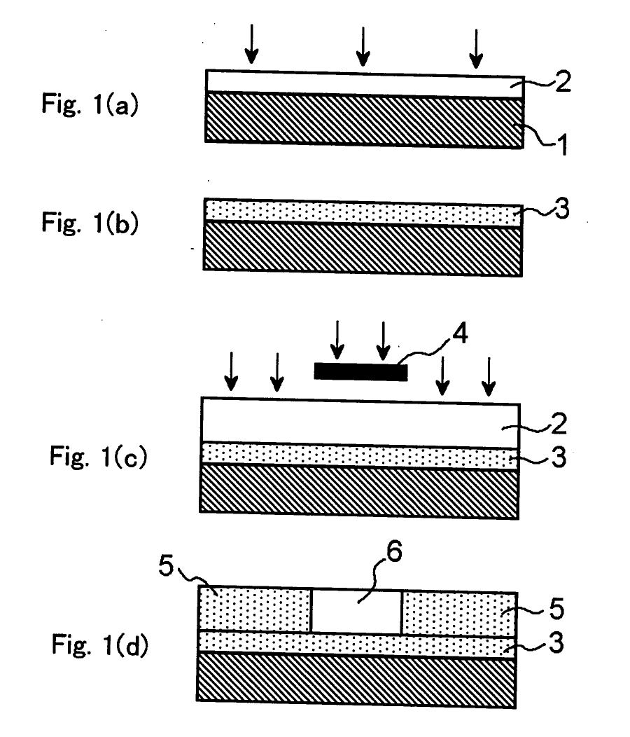

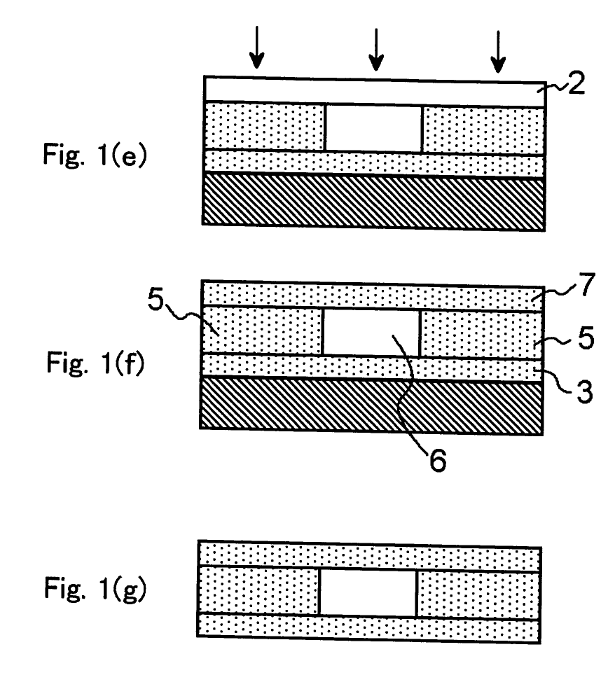

(A) a Manufacturing Method of a Polymer Optical Waveguide without Developing (FIG. 1(a) to FIG. 1(g)):

First, a lower clad layer is formed on a suitable substrate. A photosensitive resin composition layer 2 is formed as a lower clad layer, for example, by coating and pre-baking the photosensitive resin composition of the present invention on the substrate 1 as shown in FIG. 1(a). Then, the lower clad layer 3 is formed by exposing the whole surface of the layer 2 to actinic rays and subjecting it to a heat-treatment (PEB) step to make the photosensitive resin composition layer 2 of a low refractive index (FIG. 1(b)). The lower clad layer 3 may be one which uses another optional photosensitive resin composition whose refractive index becomes the same as the low refractive index, and is obtained by actinic rays- or heat-treatment.

In the present invention, as the substrate 1, for example, a silicon substrate, glass substrate, quartz substrate, glass epoxy substrate, metal substrate, ceramic substrate, polymer film and a substrate in which a polymer film is formed on various substrates, are usable, but it is not limited to these.

Next, as shown in FIG. 1(c), the photosensitive resin composition of the present invention is applied on the lower clad layer 3, and pre-baked to form a photosensitive resin composition layer 2. A method for coating the photosensitive resin composition is not especially limited, and involves, for example, spin coating by a spin coater, spray coating by a spray coater, dipping, printing, and roll coating. The pre-baking step is one which is to dry the coated photosensitive resin composition to remove solvents in the photosensitive resin composition and fix the coated photosensitive resin composition. The pre-baking step is commonly performed at 60 to 160° C.

Then, only an area in the photosensitive resin composition layer 2 corresponding to a middle clad layer 5 is irradiated with actinic rays through a photomask 4, and further heat-treated, whereby only the area corresponding to the middle clad layer 5 is exposed and heat-treated as shown in FIG. 1(d) to make a low refractive index. In contrast, since an area corresponding to a core layer 6 is not exposed and only heat-treated, the refractive index of the area corresponding to the core layer 6 is higher than that of the area corresponding to the middle clad layer 5, and as shown in FIG. 1(d), the middle clad layer 5 having a low refractive index is formed and the core layer 6 having a high refractive-index is together formed.

The exposing step is one in which the photosensitive resin composition layer 2 is selectively exposed through a photomask 4, and a waveguide pattern of the photomask 4 is transferred to the photosensitive resin composition layer 2. Now, as actinic rays used for the and later-described whole-surface exposure and this pattern exposure usable are ultraviolet rays, visible light rays, excimer laser beams, electron beams and X-rays, preferably actinic rays of 180 to 500 nm in wavelength.

The step of subjecting to PEB treatment is performed in air or an inert gas atmosphere, commonly at 100 to 250° C. The PEB treatment may be performed in a single step or multiple steps.

Further the photosensitive resin composition of the present invention is applied thereto as shown in FIG. 1(e), exposed on the whole surface to actinic rays, and heat-treated to make a low refractive index, thereby forming an upper clad layer 7 as shown in FIG. 1(f). The upper clad layer 7 may be obtained by using another optional photosensitive resin composition whose refractive index becomes the same as the low refractive index and subjecting it to actinic rays- or heat-treatment. In such a manner, a polymer optical waveguide can be fabricated in which the core layer 6 having a high refractive index is enclosed with the lower clad layer 3, middle clad layer 5 and upper clad layer 7 having a low refractive index. Further thereafter, by removing the substrate 1 by a method such as etching, a polymer optical waveguide is obtained as shown in FIG. 1(g). If a flexible polymer film is employed as the substrate 1, a flexible polymer optical waveguide is obtained.

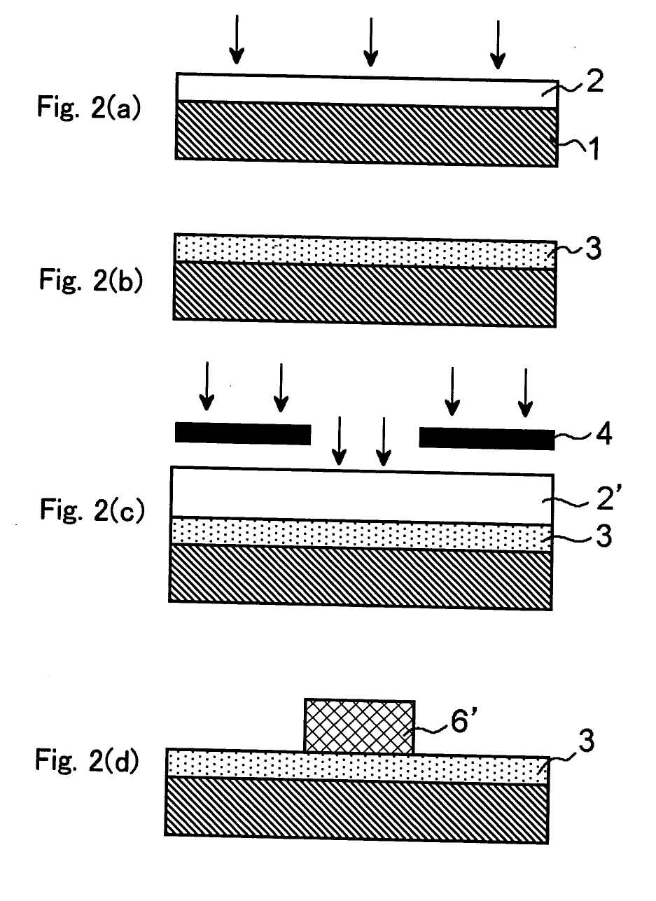

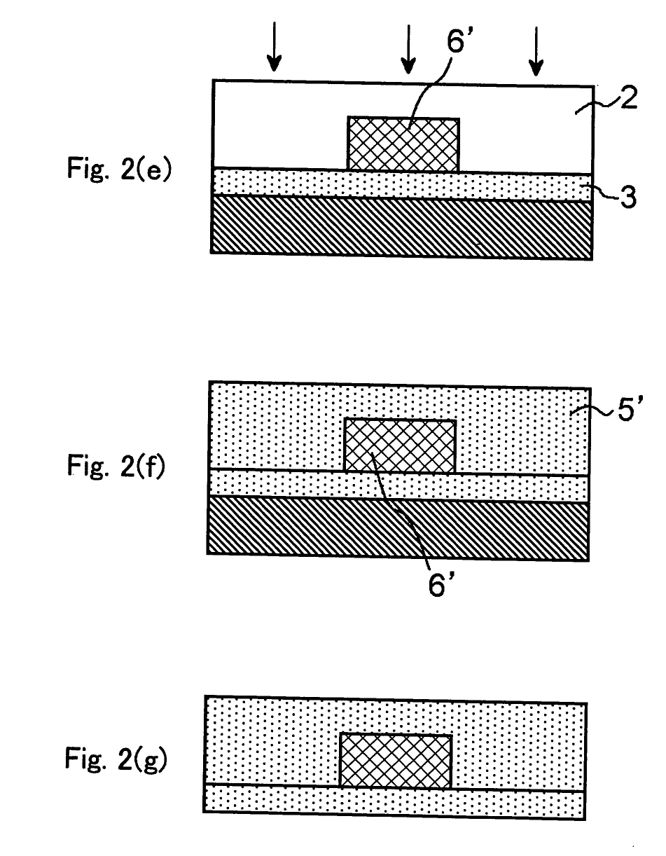

(B) A Manufacturing Method of a Polymer Optical Waveguide with a Developing Step (FIG. 2(a) to FIG. 2(g))

First, a lower clad layer 3 is formed on a suitable substrate 1. The photosensitive resin composition layer 2 is formed as a lower clad layer 3, for example, by coating and pre-baking the photosensitive resin composition of the present invention on the substrate 1 as shown in FIG. 2(a). Then, the lower clad layer 3 is formed by exposing the layer 2 on the whole surface to ultraviolet rays and subjecting it to a heat-treatment (baking) step to make the resin layer 2 of a low refractive index (FIG. 2(b)). The lower clad layer 3 may be one which uses another optional photosensitive resin composition whose refractive index becomes the same as the low refractive index, and is obtained by actinic rays- or heat-treatment.

In the present invention, as the substrate 1, for example, a silicone substrate, glass one, quartz one, glass epoxy one, metal one, ceramic one, polymer film and a substrate in which a polymer film is formed on various substrates, are usable, but it is not limited to these.

Next, as shown in FIG. 2(c), the photosensitive resin composition of the present invention is applied to the lower clad layer 3, and pre-baked to form a photosensitive resin composition layer 2′. For forming the photosensitive resin composition layer 2′, a composition having a higher refractive index than that of the lower clad layer 3 is selectively used. The adjustment of the refractive index can be performed, example, by adjusting the amount of an epoxy group contained in the photosensitive resin composition and adjusting the amount of a halogen atom, especially fluorine atom, introduced as a substituent into the general formula (1). A method for coating the photosensitive resin composition is not especially limited, and involves, for example, the spin coating using a spin coater, spray coating using a spray coater, immersion, printing, and roll coating. The pre-baking step is one which is to dry the coated photosensitive resin composition to remove solvents in the photosensitive resin composition and fix the coated photosensitive resin composition as the photosensitive resin composition layer 2′. The pre-baking step is commonly performed at 60 to 160° C.

Then, an area corresponding to a core 6′ is irradiated with actinic rays through a photomask 4 on the photosensitive resin composition layer 2′, and further subjected to PEB treatment. Then, by developing with an alkali developing solution or an organic solvent, removing the unexposed area, and thereafter further post-baking, the core layer 6′ having a high refractive index is formed on the lower clad layer 3 as shown in FIG. 2(d).

The exposing step is one in which the photosensitive resin composition layer 2′ is selectively exposed through a photomask 4, and a waveguide pattern of the photomask 4 is transferred to the photosensitive resin composition layer 2′. As actinic rays used for the and later-described whole-surface exposure and this pattern exposure usable are ultraviolet rays, visible light rays, excimer laser beams, electron beams and X-rays, preferably actinic rays of 180 to 500 nm in wavelength.

The PEB treatment is performed in air or an inert gas atmosphere, commonly at 100 to 160° C.

The developing step is one in which the unexposed area of the photosensitive resin composition layer 2′ is dissolved and removed with an alkali developing solution or an organic solvent to form the core layer 6′. The exposure and PEB treatment result in a difference of solubility (dissolution contrast) in the developing solution between the exposed part and the unexposed area of the photosensitive resin composition layer 2′. By utilizing this dissolution contrast, a core pattern is obtained by dissolving and removing the unexposed area of the photosensitive resin composition. As the alkali developing solution usable is an alkali aqueous solution of a quaternary ammonium salt such as tetramethylammonium hydroxide (TMAH) or tetraethylammonium hydroxide, an aqueous solution in which the alkali aqueous solution is added with a water-soluble alcohol such as methanol or ethanol and a surfactant in an appropriate amount, or the like. As the organic solvent specifically usable are γ-butyrolactone, propylene glycol monomethyl ether acetate, propylene glycol monoethyl ether acetate, ethyl lactate, 2-heptanone, 2-methoxybutyl acetate, 2-ethoxyethyl acetate, methylpyruvate, ethyl pyruvate, methyl 3-methoxypropionate, ethyl 3-methoxypropionate, N-methyl-2-pyrrolidone, cyclohexanone, cyclopentanone, methyl isobutyl ketone, ethylene glycol monomethyl ether, ethylene glycol monomethyl ether acetate, ethylene glycol monoethyl ether, ethylene glycol monoisopropyl ether, diethylene glycol monomethyl ether, diethylene glycol dimethyl ether, etc. These may be used alone or by mixing two or more kinds. The developing method involves methods such as puddle, immersion and spray. After the developing step, the formed pattern is rinsed with water, an organic solvent used in development or the like.

The post-baking step is performed in air or an inert gas atmosphere, commonly at 100 to 250° C. The post-baking step may be performed in a single step or multiple steps.

Further on the formed core layer 6′, the photosensitive resin composition of the present invention is coated as shown in FIG. 2(e), exposed on the whole surface to actinic rays, and heat-treated. As a result, the cured product is made of a low refractive index, and a middle and upper clad (middle and upper clad layer 5′) is collectively formed as shown in FIG. 2(f). The middle and upper clad layer 5′ may be obtained by using another optional photosensitive resin composition whose refractive index becomes the same as the low refractive index and subjecting it to ultraviolet rays- or heat-treatment. In such a manner, a polymer optical waveguide can be fabricated which is formed by enclosing the core layer 6′ having the high refractive index with the lower clad layer 3 and the middle and upper clad layer 5′ having the low refractive index. Further thereafter, by removing the substrate 1 by a method such as etching, a polymer optical waveguide can be obtained as shown in FIG. 2(g). If a flexible polymer film is employed as the substrate 1, a flexible polymer optical waveguide can be obtained.

As described above, since the photosensitive resin composition of the present invention can form a waveguide pattern with high precision and a formed optical waveguide has an excellent transmission property (low propagation loss), it is suitable as a material for forming an optical waveguide.

Hereinafter, the present invention will further specifically be described by way of examples.

### SYNTHESIS EXAMPLE 1

A polymer having the following structure, specifically, a polymer of the general formula (1), wherein R¹ to R⁵ are each a hydrogen atom, was synthesized.

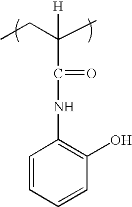

In 200 ml of N-methyl-2-pyrrolidone (NMP), 20 g of o-aminophenol was dissolved, and the solution was cooled on an ice bath. 8.546 Grams (1.1 molar equivalents) of lithium chloride was added thereto. After lithium chloride was completely dissolved, 17.42 g (1.05 molar equivalents) of acryloyl chloride was added dropwise, and the mixture was stirred for 5 hours under ice-cooling. The reaction mixture was poured into 1.8 L of water, and the organic layer was extracted with 700 ml of diethyl ether. The diethyl ether layer was washed with 0.2N hydrochloric acid, brine and water in this order, and dried over magnesium sulfate. Diethyl ether was distilled off under reduced pressure. To the solidified residue, 80 ml of diisopropyl ether was added. The mixture was stirred under heating, washed, and filtered. The filtered material was subjected to the same washing treatment to obtain 10.2 g of N-(2-hydroxyphenyl)acrylamide as a white powder (yield: 34%).

Then, 50 g of N-(2-hydroxyphenyl)acrylamide was dissolved in 117 ml of tetrahydrofuran (THF), and 0.503 g of 2,2′-azobis(isobutyronitrile) was added to the solution. The mixture was heated to reflux in an argon atmosphere for 4 hours. After being allowed to cool, the resultant was reprecipitated in 1,000 ml of diethyl ether. The precipitated polymer was separated by filtration, and the filtered material was again reprecipitated and purified to obtain 41.69 g of a target polymer (yield: 83%). The weight-average molecular weight (Mw) was 23,800 (in terms of polystyrene), and the molecular weight distribution (Mw/Mn) was 2.68 according to GPC analysis.

### SYNTHESIS EXAMPLE 2

A polymer having the following structure, specifically, a polymer having 70 mol % of a structural unit of the general formula (1), wherein R¹ to R⁵ are each a hydrogen atom, and 30 mol % of a structural unit of 3,4-epoxycyclohexyl methylmethacrylate corresponding to the general formula (2) was synthesized.

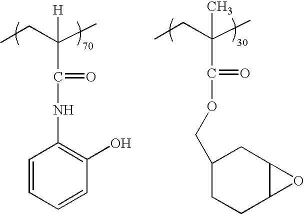

In 124 ml of THF, 28 g of N-(2-hydroxyphenyl)acrylamide and 14.43 g of 3,4-epoxycyclohexyl methylmethacrylate were dissolved, and 0.804 g of 2,2′-azobis(isobutyronitrile) was added to the solution. The mixture was heated to reflux in an argon atmosphere for 2 hours. After being allowed to cool, the resultant was reprecipitated in 1,000 ml of diethyl ether. The precipitated polymer was separated by filtration, and the filtered material was again reprecipitated and purified to obtain 35.64 g of a target polymer (yield: 84%). The weight-average molecular weight (Mw) was 14,800 (in terms of polystyrene), and the molecular weight distribution (Mw/Mn) was 3.44 according to GPC analysis.

### SYNTHESIS EXAMPLE 3

A polymer having the following structure, specifically, a polymer having 90 mol % of a structural unit of the general formula (1), wherein R¹ to R⁵ are each a hydrogen atom, and 10 mol % of a structural unit of 3,4-epoxycyclohexyl methylmethacrylate corresponding to the general formula (2), was synthesized.

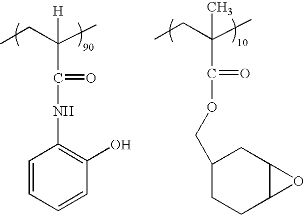

In 62 ml of THF, 18 g of N-(2-hydroxyphenyl)acrylamide and 2.41 g of 3,4-epoxycyclohexyl methylmethacrylate were dissolved, and 0.402 g of 2,2′-azobis(isobutyronitrile) was added to the solution. The mixture was heated to reflux in an argon atmosphere for 2 hours. After being allowed to cool, the resultant was reprecipitated in 1,000 ml of diethyl ether. The precipitated polymer was separated by filtration, and again reprecipitated and purified to obtain 16.33 g of a target polymer (yield: 80%). The weight-average molecular weight (Mw) was 10,800 (in terms of polystyrene), and the molecular weight distribution (Mw/Mn) was 3.78 according to GPC analysis.

### EXAMPLES 1 TO 5

Photosensitive resin compositions having composition ratios shown in Table 1 were prepared.

TABLE 1

| | | Example 1 | Example 2 | Example 3 | Example 4 | Example 5 |
|---|---|---|---|---|---|---|
| Composition | (a) Polymer | 1.8 | 1.8 | 1.8 | 1.8 | 1.8 |
| ratio (parts) | (b) Epoxy compound | 0.36 | 0.72 | 1.08 | 1.44 | 1.8 |
| | (c) Photoacid generator | 0.043 | 0.05 | 0.058 | 0.065 | 0.072 |
| | (d) Solvent | 5 | 5.4 | 5.4 | 5.4 | 5 |

| | | | | | |
|---|---|---|---|---|---|
| Refractive index (n1) with | 1.59424 | 1.59267 | 1.59142 | 1.58847 | 1.58383 |
| ultraviolet non-irradiation | | | | | |
| Refractive index (n2) after | 1.59212 | 1.58339 | 1.5747 | 1.56932 | 1.56451 |
| ultraviolet irradiation | | | | | |
| $\begin{matrix}Refractive index difference ( \% ) \\ \frac{n 1 - n 2}{n 1} \times 100\end{matrix}$ | 0.13 | 0.59 | 1.06 | 1.22 | 1.23 |

Each mixture was filtered using a 0.45 μm Teflon® filter to prepare a photosensitive resin composition. The photosensitive resin was applied on a 4-inch silicon substrate by spin coating, and baked at 90° C. for 20 minutes in an oven to form a coating film. Two sheets were prepared for each resin. Then, the whole surface of each one of the two sheets was exposed to ultraviolet rays (wavelength λ=350 to 450 nm), then heat-treated at 120° C. for 20 minutes, and thereafter baked in a nitrogen atmosphere at 150° C. for 1 hour, and at 220° C. for 1 hour. The other sheet was heated at 120° C. for 20 minutes without irradiation with ultraviolet rays, and thereafter baked in a nitrogen atmosphere at 150° C. for 1 hour, and at 220° C. for 1 hour. Then, each sample was measured for the refractive index at 633 nm using Prism Coupler instrument manufactured by Metricon Corp. The results are summarized in Table 1. Table 1 indicates that there is a difference in refractive index between the photosensitive resin composition of the present invention with ultraviolet irradiation and that with non-irradiation even if they have the same resin composition.

### EXAMPLE 6

A photosensitive resin composition containing the following components was prepared.

(a) Polymer obtained in Synthesis Example 1: 15 g

(b) 3,4-Epoxycyclohexylmethyl 3,4-epoxycyclohexanecarboxylate: 12 g

(c) Trifluoromethylsulfonic acid ester of N-hydroxynaphthylimide: 0.54 g

(d) γ-Butyrolactone: 18 g

The mixture was filtered using a 0.45 μm Teflon® filter to prepare a photosensitive resin composition. The composition was applied on a 4-inch silicon substrate by spin coating, and baked at 90° C. for 20 minutes in an oven to form a film of 20 μm in thickness. Then, the whole surface of the film was exposed to ultraviolet rays (wavelength λ=350 to 450 nm) at 1,000 mJ/cm², and after the exposure, baked at 120° C. for 20 minutes in an oven, and further baked in a nitrogen atmosphere at 150° C. for 1 hour and at 220° C. for 1 hour to form a lower clad layer. Then, said photosensitive resin composition was applied on the lower clad layer by spin coating, and baked at 90° C. for 20 minutes in an oven to form a film of 50 μm in thickness. Next, the film was exposed through a photomask to ultraviolet rays (wavelength λ=350 to 450 nm) at 1,000 mJ/cm². After the exposure, the film was baked at 120° C. for 20 minutes in an oven, and further baked in a nitrogen atmosphere at 150° C. for 1 hour and at 220° C. for 1 hour to form a patterned core layer and middle clad layer. Then, said resin composition was further applied on the formed core layer and middle clad layer by spin coating, and baked at 90° C. for 20 minutes in an oven to form a film of 20 μm in thickness. Then, the whole surface of the film was exposed to ultraviolet rays (wavelength λ=350 to 450 nm) at 1,000 mJ/cm², and after the exposure, the film was baked at 120° C. for 20 minutes in an oven, and further baked in a nitrogen atmosphere at 150° C. for 1 hour and at 220° C. for 1 hour to form an upper clad layer, thereby obtaining a polymer optical waveguide.

After end faces of the optical waveguide were diced by a dicer, the optical waveguide was evaluated for the propagation loss using the cutback method (see JIS C6823 “Measuring methods for attenuation of optical fibers”) at a wavelength of 850 nm. The propagation loss was 0.5 dB/cm. The cross-sectional shape of the clad layer was rectangular.

### EXAMPLE 7

A photosensitive resin composition for forming a lower clad and an upper clad (hereinafter referred to as “Composition A”), containing the following components, was prepared.

(a) Polymer obtained in Synthesis Example 2: 15 g

(b) 3,4-Epoxycyclohexylmethyl 3,4-epoxycyclohexanecarboxylate: 4.5 g

(c) Trifluoromethylsulfonic acid ester of N-hydroxynaphthylimide: 0.39 g

(d) γ-Butyrolactone: 19.5 g

A photosensitive resin composition for forming a core (hereinafter referred to as “Composition B”), containing the following components, was prepared.

(a) Polymer obtained in Synthesis Example 3: 15 g

(b) 3,4-Epoxycyclohexylmethyl 3,4-epoxycyclohexanecarboxylate: 1.5 g

(c) Trifluoromethylsulfonic acid ester of N-hydroxynaphthylimide: 0.33 g

(d) γ-Butyrolactone: 16.5 g

Each mixture was filtered using a 0.45 μm Teflon® filter to prepare a photosensitive resin composition. Then, Composition A was applied on a 4-inch silicon substrate by spin coating, and baked at 90° C. for 20 minutes in an oven to form a film of 20 μm in thickness. Then, the whole surface of the film was exposed to ultraviolet rays (wavelength λ=350 to 450 nm) at 1,000 mJ/cm², and after the exposure, the film was baked at 90° C. for 10 minutes in an oven, and further baked in a nitrogen atmosphere at 220° C. for 30 minutes to form a lower clad layer. Then, Composition B was applied on the lower clad layer by spin coating, and baked at 90° C. for 20 minutes in an oven to form a film of 50 μm in thickness. Next, the film was irradiated through a photomask with ultraviolet rays (wavelength λ=350 to 450 nm) at 1,000 mJ/cm², and baked at 90° C. for 10 minutes in an oven. Then, the film was developed for 5 minutes in a 2.38% tetramethylammonium hydroxide aqueous solution by the immersion method, and successively subjected for 2 minutes to rinsing treatment with purified water. As a result, only the unexposed area of the photosensitive resin film was dissolved and removed in the developing solution, thereby obtaining a core pattern. Then, by baking in a nitrogen atmosphere at 220° C. for 30 minutes, a core pattern was completely cured to form a core layer. Next, Composition A was applied on the core layer by spin coating, and baked at 90° C. for 20 minutes in an oven to form a film of 20 μm in thickness. Then, the whole surface of the film was exposed to ultraviolet rays (wavelength λ=350 to 450 nm) at 1,000 mJ/cm², and after the exposure, the film was baked at 90° C. for 10 minutes in an oven, and further baked in a nitrogen atmosphere at 220° C. for 30 minutes to form an upper clad layer, thereby obtaining a polymer optical waveguide.

After end faces of the optical waveguide were diced by a dicer, the optical waveguide was evaluated for the propagation loss using the cutback method at a wavelength of 850 nm. The propagation loss was 0.4 dB/cm. The cross-sectional shape of the clad layer was rectangular.

As is clear from the above description, the photosensitive resin composition for forming a polymer optical waveguide of the present invention can be used for forming a waveguide pattern with high precision, and since a formed optical waveguide has an excellent transmission property (low propagation loss), the composition is suitable as a material for forming an optical waveguide.

What is claimed is:

1. A photosensitive resin composition for forming an optical waveguide, which comprises, at least,
a (meth)acrylamide polymer comprising at least one repeating structural unit represented by the following general formula (1): 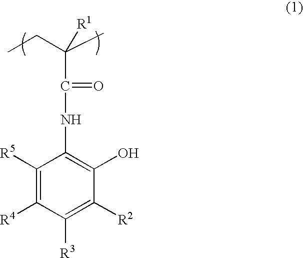
wherein R¹ represents a hydrogen atom or methyl group; and R² to R⁵ each independently represent a hydrogen atom, a halogen atom or an alkyl group having 1 to 4 carbon atoms, and
a photoacid generator.

2. The photosensitive resin composition for forming an optical-waveguide according to claim 1, wherein the polymer further comprises a structural unit represented by the following general formula (2): 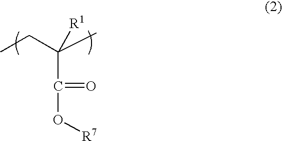
wherein R⁶ represents a hydrogen atom or methyl group; and R⁷ represents a hydrocarbon group having an epoxy group.

3. The photosensitive resin composition for forming an optical waveguide according to claim 1, which further comprises an epoxy compound.

4. The photosensitive resin composition for forming an optical waveguide according to claim 1, which further comprises at least one additive selected from the group consisting of alumina, silica, glass fiber, glass bead, silicone, titanium oxide and oxides of other metals.

5. An optical waveguide comprising a core layer and a clad layer stacked on the core layer, wherein either or both of the core layer and the clad layer are composed of a cured product of a photosensitive resin composition for forming an optical waveguide according to claim 1.

6. An optical waveguide comprising a core layer and a clad layer stacked on the core layer, wherein either or both of the care layer and the clad layer are composed of a cured product of a photosensitive resin composition for forming an optical waveguide according to claim 2.

7. An optical waveguide comprising a core layer and a clad layer stacked on the core layer, wherein either or both of the care layer and the clad layer are composed of a cured product of a photosensitive resin composition for forming an optical waveguide according to claim 3.

8. An optical waveguide comprising a core layer and a clad layer stacked on the core layer, wherein either or both of the care layer and the clad layer are composed of a cured product of a photosensitive resin composition for forming an optical waveguide according to claim 4.

9. A method for forming an optical waveguide pattern, comprising at least the following steps:
(1) forming a lower clad layer on a substrate;
(2) applying a resin composition for forming an optical waveguide on the lower clad layer;
(3) pre-baking the resin composition to form a resin composition layer;
(4) irradiating an area other than an area to be a core layer of the resin composition layer with actinic rays through a mask;
(5) subjecting to post-exposure bake treatment; and
(6) forming an upper clad layer on the resin composition layer after the post-exposure bake,
wherein the resin composition for forming an optical waveguide comprises, at least, a polymer comprising at least one repeating structural unit represented by the following general formula (1): 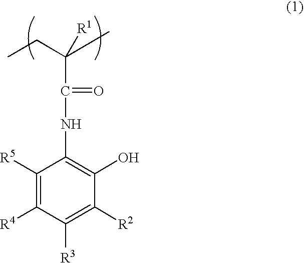
wherein R¹ represents a hydrogen atom or methyl group; and R² to R⁵ each independently represent a hydrogen atom, a halogen atom or an alkyl group having 1 to 4 carbon atoms, and a photoacid generator.

10. The method for forming an optical waveguide pattern according to claim 9, wherein either or both of the lower clad layer and the upper clad layer are obtained by curing the resin composition for forming an optical waveguide after irradiating the composition with actinic rays.

11. The method for forming an optical waveguide pattern according to claim 9, wherein said polymer further comprises a structural unit represented by the following general formula (2): 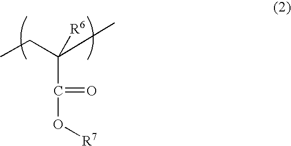
wherein R⁶ represents a hydrogen atom or methyl group; and R⁷ represents a hydrocarbon group having an epoxy group.

12. The method for forming an optical waveguide pattern according to claim 9, wherein the photosensitive resin composition for forming an optical waveguide further comprises an epoxy compound.

13. The method for forming an optical waveguide pattern according to claim 9, wherein the photosensitive resin composition for forming an optical waveguide further comprises at least one additive selected from the group consisting of alumina, silica, glass fiber, glass bead, silicone, titanium oxide and oxides of other metals

14. A method for forming an optical waveguide pattern, comprising at least the following steps:
(1) forming a lower clad layer on a substrate;
(2) applying a resin composition for forming an optical waveguide on the lower clad layer;
(3) pre-baking the resin composition to form a resin composition layer;
(4) irradiating an area other than an area to be a core layer of the resin composition layer with actinic rays through a mask;
(5) subjecting to post-exposure bake treatment;
(6) developing to remove an unexposed area;
(7) post-baking to form the core layer; and
(8) forming a middle and upper clad layer on the formed core layer and the lower clad layer,
wherein the resin composition for forming an optical waveguide comprises, at least, a polymer comprising at least one repeating structural unit represented by the following general formula (1): 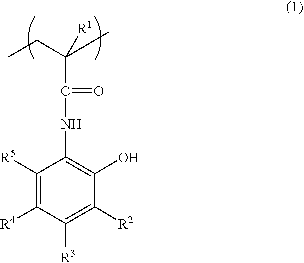
wherein R¹ represents a hydrogen atom or methyl group; and R² to R⁵ each independently represent a hydrogen atom, halogen atom or an alkyl group having 1 to 4 carbon atoms, and a photoacid generator.

15. The method for forming a waveguide pattern according to claim 14, wherein either or both of the lower clad layer and the middle and upper clad layers are obtained by irradiating the resin composition for forming an optical waveguide having a refractive index lower than the core layer with actinic rays, and then curing the composition.

16. The method for forming a waveguide pattern according to claim 14, wherein said polymer further comprises a structural unit represented by the following general formula (2): 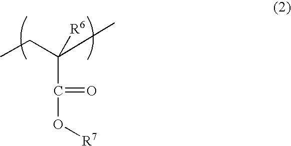
wherein R⁶ represents a hydrogen atom or methyl group; and R⁷ represents a hydrocarbon group having an epoxy group.

17. The method for forming a waveguide pattern according to claim 14, wherein the photosensitive resin composition for forming an optical waveguide further comprises an epoxy compound.

18. The method for forming a waveguide pattern according to claim 14, wherein the photosensitive resin composition for forming an optical waveguide further comprises at least one additive selected from the group consisting of alumina, silica, glass fiber, glass bead, silicone, titanium oxide and oxides of other metals.
